(19) United States
(12) Patent Application Publication
(10) Pub. No.: US 2024/0026929 A1
(43) Pub. Date: Jan. 25, 2024

(54) STATIC SEAL AND DRIVE WHEEL HUB ASSEMBLY INCORPORATING SAME

(71) Applicant: NTN EUROPE, Annecy (FR)

(72) Inventor: Vincent POURROY-SOLARI, Thônes (FR)

(73) Assignee: NTN EUROPE, Annecy (FR)

(21) Appl. No.: 18/356,177

(22) Filed: Jul. 20, 2023

(30) Foreign Application Priority Data
Jul. 22, 2022 (FR) 2207748

(51) Int. Cl. F16C 33/78

(52) U.S. Cl. CPC F16C 33/7883; F16C 2326/02

(57) ABSTRACT

An annular static seal for a drive wheel hub assembly including a wheel hub, a torque converter and an inner race shrunk onto the wheel hub and axially held by a flange forming a rear end of the wheel hub, is adapted, in a mounting position, to cover an annular outer perimeter of an interface between the wheel hub and the torque converter located at the rear end of the wheel hub. The static seal includes a resiliently deformable annular fastening portion protruding radially toward the reference axis, producing a resilient fastening of the static seal to the wheel hub.

### CROSS-REFERENCE TO RELATED APPLICATIONS

This application claims the benefit of priority under 35 U.S.C. 119 to French Patent Application No. 2207748, filed Jul. 27, 2022; the disclosure of which is incorporated herein by reference in its entirety.

### FIELD

The invention relates to a drive wheel hub assembly including a wheel hub and a torque converter, and more specifically to the protection of an interface between the wheel hub and the torque converter.

### BACKGROUND

In drive wheel hub assemblies, a wheel hub is guided in rotation by a rolling bearing mechanically secured to a wheel support. In order to transmit the rotational movement coming from the transmission of the motor vehicle to the drive wheels, the hub is constrained to rotate with a torque converter, most often by interpenetration of two sets of splines.

In the remainder of the description, reference will be made to an axis of revolution of the wheel hub assembly, and to an orientation along this axis with a front and a rear which respectively correspond to the side where a wheel is mounted on the wheel hub (exterior side of the vehicle), and on the side where the transmission is connected to the torque converter (interior side of the vehicle).

The rotationally fixed connection of the drive wheel hub and the torque converter is done at an interface, that is to say a mutual contact area, which may have a portion extending in the longitudinal direction and a portion extending in the radial direction relative to the axis of revolution of the wheel hub assembly. This interface may include a set of face or radial splines formed on the parts of the wheel hub and of the torque converter that mate with one another. The splines are said to be “radial” when the flanks of the splines project in the radial direction from the spline bottom, the bottoms of the splines then preferably being situated approximately on the same cylinder and extending in the longitudinal direction. They are said to be “face” when the flanks of the spline project axially from the spline bottom, the bottoms of the splines then preferably being located approximately in the same plane perpendicular to the axis of revolution, or on the same surface that is approximately frustoconical or toroid around the axis of revolution, and extending in the radial direction. The wheel hub is mechanically connected to a wheel support by a rolling bearing with one or several rows of rolling elements, including an inner race called the “rear” race that faces the torque converter.

In all the configurations described the interface between the torque converter and the annular hub has a radially outer perimeter, preferably located at a rear longitudinal end of the torque converter, close to the rear inner race of a rolling bearing, and possibly being separated from the rear inner race by a bead of material formed at the inner longitudinal end of the hub, for example by heading. In the event that the interface comprises face splines, they can extend to this outer radial perimeter, which will then have a splined profile. In the absence of face splines, the exterior radial perimeter of the interface can be circular. In the presence of face splines, the perimeter may have gaps due to imperfect nesting of the splines.

However, because of the very exposed position of the drive wheel hub assembly, its components are subjected to projections from the wheel or from the road. It is therefore recommended, in the prior art relating to face spline interfaces, to provide a static seal to cover the exterior perimeter of the interface and protect the splines against the penetration of pollutants. In the prior art, these static sealing devices consist of a static seal mechanically connected to an inner race of the rear rolling bearing. Furthermore, the rear rolling bearing is protected by a dynamic seal, for example a cassette seal, inserted between the inner race and an outer race on the side of the torque converter. In addition, an axial encoder is usually mounted against the inner race of the rear bearing.

This configuration leads to the fitting of numerous parts in a reduced area and requires a static seal of complex shape that comprises flexible parts which are most often assembled by overmolding onto metal reinforcements of complex shapes.

Documents EP 2 042 755 A2 and US 2011/077089 A1 describe such composite static sealing devices, which are able to cover a gap formed between the face splines of a rear end of the wheel hub and a front face of a torque converter. These composite static sealing devices have an axial sealing surface able to press against a rear face of an inner race of a rolling bearing of the wheel hub, and a radial sealing surface able to press the perimeter of a bulbous extension of the torque converter.

The static seals of the prior art are generally shrunk onto the inner race or on the torque converter, which imposes narrow manufacturing and mounting tolerances, hence a high manufacturing and assembly cost.

In addition, no recommendation is made to protect the interfaces between the torque converter and the wheel hub in the absence of face splines, probably because such protection seems superfluous. However, corrosion risks have been observed on all the interfaces, both with face splines and radial splines, which are suspected of being a cause of micro-friction and noise when the vehicle is running.

### SUMMARY

The purpose of the present invention is to remedy all or some of the disadvantages of the prior art by proposing in particular a static seal that is easy to assemble and is intended to be used both for face spline interfaces and for interfaces without face splines.

To this end, the invention relates, according to a first aspect, to an annular static seal for a drive wheel hub assembly including a wheel hub, a torque converter and an inner race shrunk onto the wheel hub and held axially by a flange forming a rear end of the wheel hub, the static seal defining a reference axis and being adapted, in a mounting position, to cover an annular outer perimeter of an interface between the wheel hub and the torque converter located at the rear end of the wheel hub, the static seal comprising at least one rear sealing surface adapted, in the mounting position, to be in continuous annular bearing on a rear static seal seat formed on the torque converter, and at least one front sealing surface adapted, in the mounting position, to be in continuous annular bearing on a front static seal seat formed on the flange of the wheel hub, on the inner race or on a deflector or an encoder attached to the inner race. According to the invention, the static seal comprises a resiliently deformable annular fastening portion protruding radially toward the reference axis, able to be brought into the mounting position by axial movement of the static seal toward the inner race and by resilient collapse of the fastening portion when passing the flange of the wheel hub, and to be positioned, in the mounting position, axially between a transverse face of the inner race and a face of the flange of the wheel hub facing the inner race while providing a resilient fastening of the static seal to the wheel hub.

In the mounting position, an inner radial end of the fastening portion is closer to the reference axis than an outer radial end of the flange of the wheel hub, which ensures a locking of the shape of the static seal in axial direction, and a forced locking in the circumferential direction.

It is provided that before assembly, the reference axis is located at a distance D1 from the fastening portion and at a distance D2 from a transition portion of the static seal, that transition portion being intended to be positioned, in the mounting position, radially opposite a portion of the flange of the wheel hub furthest from the reference axis, and that one or more of the following dimensional features are achieved:

D2−D1>2 mm

D2−D1>5 mm

D2−D1<8 mm

D2−D1<10 mm.

These dimensions ensure easy mounting and effective fastening. The lowest values of the defined range will make it possible to reduce the mounting force, and will optionally simplify molding of the static seal. The higher values will not result in a more effective attachment and locking.

According to one embodiment, the static seal comprises an intermediate portion connecting the fastening portion and the rear sealing surface or one of the rear sealing surfaces, and adapted, in the mounting position, to cover the outer perimeter of the interface between the wheel hub and the torque converter.

According to a particularly advantageous embodiment, the intermediate portion, which may be a sleeve, has bending and torsion stiffness substantially lower than that of the fastening portion, to mechanically decouple the front sealing surface from the rear sealing surface and to ensure that relative movement between the torque converter and the wheel hub, induced by the dynamic stresses while in operation, does not cause loss of contact at the fastening portion. For the same reasons, the intermediate portion has a bending and torsion stiffness substantially lower than that of a rear sealing portion on which the rear sealing surface is formed.

According to one embodiment, the intermediate portion delimits with the front sealing surface, or one of the front sealing surfaces or the rear sealing surface, or one of the rear sealing surfaces in the mounting position, a sealed annular volume surrounding the outer perimeter of the interface between the wheel hub and the torque converter, for example of more than 300 mm³, preferentially more than 1000 mm³, and for example less than 2000 mm³, preferably of less than 1500 mm³.

Various configurations of the rear sealing surface can be envisaged. Preferably, at least one of the following features is achieved:
the rear sealing surface or one of the rear sealing surfaces is adapted, in the mounting position, to radially bear on a cylindrical rear static seal seat formed on the torque converter;
the rear sealing surface or one of the rear sealing surfaces is adapted, in the mounting position, to axially bear on a flat rear static seal seat formed on the torque converter;
the rear sealing surface or one of the rear sealing surfaces is adapted, in the mounting position, to bear on a frustoconical rear static seal seat formed on the torque converter;
the rear sealing surface or one of the rear sealing surfaces is formed by a sealing lip adapted, in the mounting position, to bear against a rear static seal seat formed on the torque converter, the sealing lip preferably having a converging profile oriented toward the torque converter.

The constituent material(s) of the static seal must allow resilient deformations, in particular for fastening, but also for the production of the seals at the front and rear sealing surfaces. According to one embodiment, the static seal includes a body made of a plastic material, for example an elastomer or thermoplastic material, and forming at least in part the fastening portion, and preferably the front sealing surface or at least one of the front sealing surfaces and/or the rear sealing surface or one of the rear sealing surfaces.

If necessary, a reinforcement may be provided, made of a material that is more rigid than the body. One of the following arrangements may in particular be provided:

the rigid reinforcement is adapted, in the mounting position, to be shrunk onto the torque converter;
the rigid reinforcement surrounds the rear sealing surface;
the rigid reinforcement surrounds the fastening portion;
the rigid reinforcement constitutes an encoder, in particular a magnetic or optical encoder;
the rigid reinforcement carries an encoder, in particular a magnetic or optical encoder.

Additional functions can be assigned to the static seal. It is possible in particular to provide that the static seal includes:
a baffle device protruding radially outwards and able to mate with a complementary element rigidly connected to a wheel support and located near the static seal in the mounting position, and/or
an encoder, in particular a magnetic or optical encoder.

Various alternatives of the front seal are envisaged:
the front sealing surface or one of the front sealing surfaces is formed on the fastening portion; and/or
the front sealing surface or one of the front sealing surfaces is adapted, in the mounting position, to be in continuous annular bearing against a face of the flange facing toward the inner race; and/or
the front sealing surface or one of the front sealing surfaces is adapted, in the mounting position, to be in continuous annular bearing against a face of the flange facing away from the reference axis.

It may also be desired, with the front seal, to protect a contact interface between the inner race and the flange of the wheel hub. Thus, according to one embodiment of the invention, the front sealing surface or one of the front sealing surfaces is adapted, in the mounting position, to be in continuous annular bearing with the inner race or on a deflector or an encoder attached to the inner race, one or more of the following features preferably being achieved:
the front sealing surface or one of the front sealing surfaces is adapted, in the mounting position, to radially bear on a cylindrical front static seal seat formed on the inner race or on a deflector or an encoder attached to the inner race;
the front sealing surface or one of the front sealing surfaces is adapted, in the mounting position, to axially bear on a flat front static seal seat formed on the inner race or on a deflector or an encoder attached to the inner race;
the front sealing surface or one of the front sealing surfaces is adapted, in the mounting position, to bear on an edge, either sharp or not, formed on the inner race or on a deflector or an encoder attached to the inner race;
the front sealing surface or one of the front sealing surfaces is formed by a front sealing lip adapted, in the mounting position, to bear on a front static seal seat formed on the race or on a deflector or an encoder attached to the inner race.

Naturally, seals on the inner race and the wheel hub flange can be combined. Thus, according to one embodiment, the front sealing surface(s) comprise(s) at least one first front sealing surface adapted, in the mounting position, to bear on a first front static seal seat formed on the inner race or on a deflector or an encoder attached to the inner race, and a second front sealing surface adapted, in the mounting position, to bear on a front static seal seat formed on the flange of the wheel hub.

According to another aspect of the invention, the invention relates to a drive wheel hub assembly including a wheel hub, a torque converter, an inner race shrunk onto the wheel hub and axially retained by a flange forming a rear end of the wheel hub, the wheel hub and the torque converter having an interface with an annular outer perimeter at the rear end of the wheel hub, the assembly further comprising a static seal as described above, positioned in the mounting position and the reference axis of which coincides with an axis of revolution of the wheel hub.

According to one embodiment, the torque converter comprises a set of splines and radial ribs mating with a set of splines and radial ribs formed on the wheel hub, and located axially at a distance from the rear end of the wheel hub. Preferably, the wheel hub comprises a planar, toroidal or frustoconical annular rear contact surface in surface contact with a planar, toroidal or frustoconical annular contact surface of the torque converter, the outer perimeter being formed on the outer periphery of the rear contact surface of the wheel hub and of the annular contact surface of the torque converter. According to one embodiment, the torque converter comprises a set of face splines and ribs mating with a set of face splines formed at the rear end of the wheel hub.

Where appropriate, the sealed annular volume previously mentioned is filled with an at least partially liquid or pasty product, for example a lubricant, or a material with a porous polymer matrix containing a liquid or pasty lubricant.

According to another aspect of the invention, a method for mounting the static seal as described above takes place as follows: the sealing sleeve is first fitted onto the bulbous extension of the torque converter, and then the torque converter is brought closer to the wheel hub until the front end of the sealing sleeve bears against the rear face of the inner race.

According to another aspect of the invention, a method for mounting the static seal as described above takes place as follows: the annular fastening portion of the seal is first attached to the wheel hub, then the torque converter is brought closer to the wheel hub and fitted into the seal.

Other features and advantages of the invention are highlighted by the following description of non-limiting exemplary embodiments of the various aspects of the invention.

### BRIEF DESCRIPTION OF THE FIGURES

The description refers to the appended figures which are also given by way of non-limiting exemplary embodiments of the invention:

FIG. 1 is a longitudinal sectional view of a drive wheel hub assembly equipped with a static seal according to a first embodiment of the invention;

FIG. 2 shows a detail of FIG. 1;

FIG. 3 is a detailed view of a drive wheel hub assembly equipped with a static seal according to a second embodiment of the invention;

FIG. 4 is a detailed view of a drive wheel hub assembly equipped with a static seal according to a third embodiment of the invention;

FIG. 5 is a detailed view of a drive wheel hub assembly equipped with a static seal according to a fourth embodiment of the invention;

FIG. 6 is a detailed view of a drive wheel hub assembly equipped with a static seal according to a fifth embodiment of the invention;

FIG. 7 is a detailed view of a drive wheel hub assembly equipped with a static seal according to a sixth embodiment of the invention.

For greater clarity, identical or similar elements are identified by identical reference signs in all of the Figures.

### DETAILED DESCRIPTION

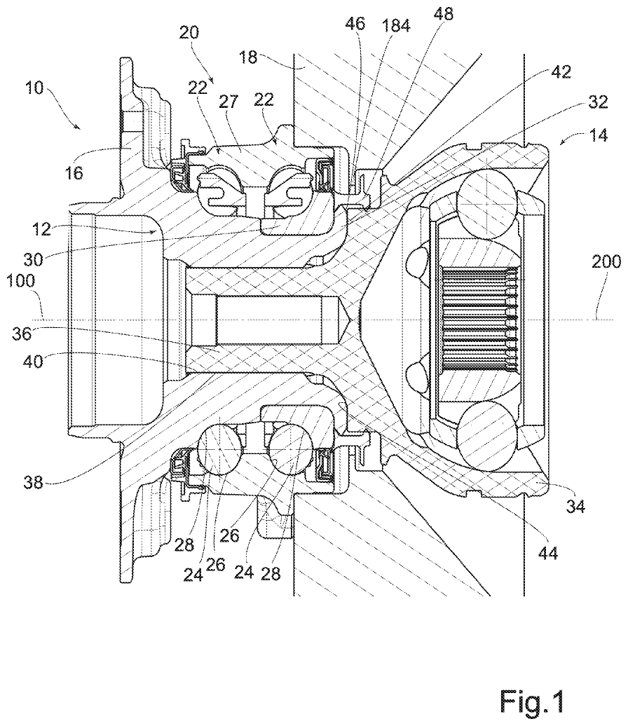

FIG. 1 shows a drive wheel hub assembly 10 comprising a wheel hub 12 and a torque converter 14, both made of steel. The wheel hub 12 has a flange 16 for fastening a wheel rim and a brake disc (not shown), and is guided in rotation about an axis of revolution 100 relative to a wheel support 18 by a rolling bearing 20. The wheel support 18 is connected to a part of a motor vehicle chassis by means of a suspension (not shown). It is recalled that by convention, we will refer to front and rear to designate, respectively, along the axis of revolution 100 the exterior side of the vehicle (on the left in FIG. 1) and the interior side of the vehicle (on the right in FIG. 1).

The rolling bearing 20, shown by way of example in the figures, preferably has two rows 22 of rolling elements 24, here balls, with two outer raceways 26 formed on a single outer race 27, and two inner raceways 28, one formed here directly on the wheel hub 12, and the other formed on an inner race 30 attached to the wheel hub 12, here by shrunk-fit, and secured axially by a flange 32 of the wheel hub, formed for example by heading. According to variants not shown, the front inner race raceway 28 can be formed on an attached race. The outer raceways 26 can be formed on two distinct races. The configuration of the raceways 26, 28 may for example be in “O” or “X”. The rolling elements 24 may be conical or cylindrical balls or rollers and may differ, by their size or shape, from one row 22 to another. The rolling bearing 20 is preferably equipped with a sealing device 33, which may, where appropriate, be a cassette seal, and which may comprise a deflector 332 mounted on the inner race 30, this deflector possibly, where appropriate, integrating an encoder 334, preferably a magnetic or optical one, adapted to deliver an angular or absolute position or displacement signal to a sensor (not shown) that is fixed relative to the wheel support 18.

The torque converter 14 is formed by a bulbous piece 34 extended forward by a nose 36. A set of splines and radial ribs 38 formed on the cylindrical perimeter of the nose 36 which are engaged with a set of splines and complementary ribs 40 formed on the inner perimeter of a through or blind tubular recess of the wheel hub 12. These radial splines 38 serve to transmit a drive torque from the torque converter 14 to the wheel hub 12 and to the drive wheel carried by the wheel hub 12.

The rear end 42 of the wheel hub 12 consists of a rear face, preferably flat, of the flange 32, which comes to bear against a corresponding shoulder 44 of the torque converter.

According to a variant not shown, the motor torque can also be transmitted by cooperation between two sets of face splines and ribs, formed on the rear face 42 of the flange 32 and the corresponding shoulder 44 of the torque converter 14, which may if necessary replace the sets of splines and radial ribs 38, 40. The permanent rotational coupling between the torque converter 14 and the wheel hub 12 can also be achieved by other means.

The shapes of the rear face 42 and of the corresponding surface 44 of the torque converter may vary, and may or may not be complementary.

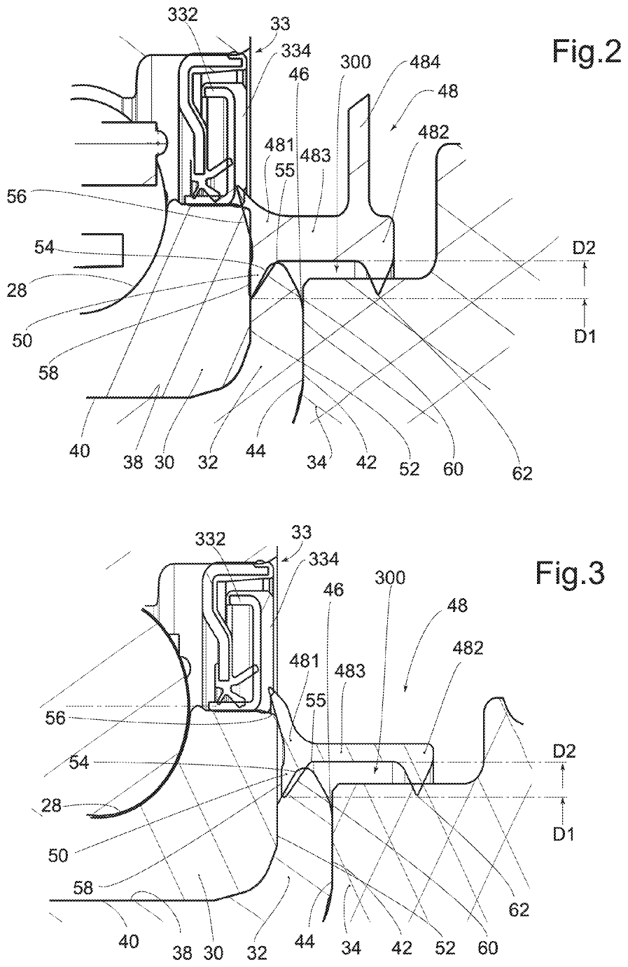

In all the envisaged configurations, the contact interface between the torque converter 14 and the wheel hub 12 has an outer perimeter 46, which should be protected, according to the invention, by a static seal 48, various exemplary embodiments of which are shown in FIGS. 2 to 7.

FIG. 2 shows a first exemplary embodiment of the static seal 48. The static seal 48 has a rotational symmetry about a reference axis 200, which coincides with the axis of revolution 100 of the wheel hub assembly 10 when the seal 48 is mounted. By analogy with the front-rear orientation given to the wheel hub assembly 10, the seal 48 is oriented between a front end which, when the seal is mounted, is turned axially toward the inner raceways 28 and the flange 16 of the wheel hub 12, and a rear end which, when the seal is mounted, faces the bulbous piece 34 of the torque converter 14. With this orientation, the static seal 48 has a front portion 481, a rear portion 482 and an intermediate portion 483 for connecting between front portion 481 and rear portion 482.

Notably, the front portion 481 of the static seal 48 includes a resiliently deformable annular fastening portion 50 protruding radially toward the reference axis 200 and positioned, in the mounting position, axially and radially between a transverse face 52 of the inner race 30 and a face 54 of the flange 32 turned toward the inner race 30 by producing a resilient fastening of the static seal 48 to the wheel hub 12.

To give an order of magnitude of the radial protrusion consisting of the fastening portion 50, the shortest distance D1 between the reference axis 200 and the fastening portion can be compared to the shortest distance D2 between the reference axis 200 and a transition portion 55 of the static seal 48 directly adjacent to the fastening portion 50 towards the rear, and intended to cover, with or preferably without contact, the part of the flange 32 furthest from the reference axis. To ensure proper attachment, D2-D1 will preferably be chosen to be >2 mm, or D2−D1>5 mm. In order not to hinder the assembly, D2-D1 will preferably be chosen to be <10 mm, and in practice D2-D1<8 mm.

The resiliency of the static seal 48 makes it possible to bring the fastening portion 50 into the mounting position by axial movement of the static seal 48 forward and by resilient collapse of the fastening portion 50 which moves away from the reference axis 200 by passing the flange 32 of the wheel hub 12.

In this example, the front portion includes three front sealing surfaces intended to each bear against a static seal seat made on the inner race 30 or on the flange 32 of the wheel hub 12. A first sealing surface 56 is made by a sealing lip that comes into quasi-linear contact with a rim of the inner race 30 and/or which may if appropriate come into quasi-linear contact with the deflector 332 or the encoder 334 of the sealing device 33 while the other two sealing surfaces 58, 60 are in surface contact the one with the inner race 30 (planar contact) and the other with the flange 32 (frustoconical contact).

In this example, the rear portion includes a sealing lip 62 which, in the mounting position, bears on a cylindrical static seal seat made on the torque converter 14.

In the mounting position, the intermediate portion 483 delimits with the front sealing surface 60 and the rear sealing surface 62 a sealed annular volume 300 surrounding the outer perimeter 46 of the interface between the wheel hub 12 and the torque converter 14. This volume is preferably greater than 500 mm 3 and less than 2000 mm 3 . It may if appropriate be filled with an at least partially liquid or pasty product, for example a lubricant, or a material with a porous polymer matrix containing a liquid or paste lubricant, with the aim of delaying the oxidation of the interface, at the rear face 42 of the wheel hub 12 and of the shoulder 44 of the torque converter 14, or even beyond, under the assumption that the oxidation would spread from the outer perimeter 46 toward the radial splines 38, 40.

Here, the intermediate portion 483 includes a sleeve and a flange 484 protruding radially outwards and intended to mate with a complementary element 184 (FIG. 1) fixed relative to the wheel support 18 and located in the vicinity of the static seal 48 to produce a baffle and, if applicable, a contactless dynamic seal. According to variants not shown, the location of the flange 484 can be different, and the flange can be installed if necessary in either the rear portion 482 or in the front portion 481 of the seal 48.

The seal 48 of the embodiment of FIG. 3 differs from the foregoing essentially by lacking a sealing flange, and by a reduction in the thickness of the intermediate portion 483, which forms a sleeve having low bending stiffness and torsion, thereby making it possible to decouple the front portion 481 from the rear portion 482 of the seal 48, so that the relative dynamic micro-movements between the torque converter 14 and the wheel hub 12 do not result in excessive forces at the front sealing surfaces 56, 58, 60 and rear sealing surfaces 62.

In this embodiment, the static seal 48 is made integrally with a single-piece body without an insert.

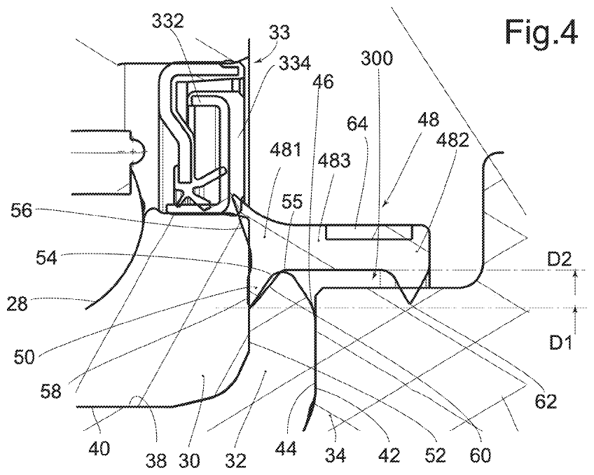

The seal 48 shown in FIG. 4 differs from the preceding ones by the addition of a ring-shaped magnetic or optical encoder 64 flush with the exterior surface of the body of the seal 48. The signal provided by this encoder is intended to be read by a sensor rigidly connected to a non-rotating part, in particular the wheel support 18, and to provide for example information on the relative or absolute angular or angular displacement or angle of the wheel hub.

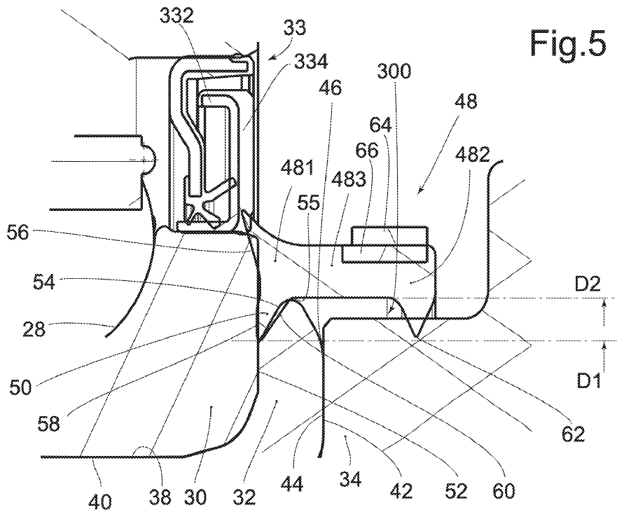

The seal shown in FIG. 5 differs from the preceding one by the superposition of an encoder ring 64 carried by the static seal and a reinforcement insert 66 embedded in the elastomeric body of the static seal. The holding function provided by the insert 66 is decoupled from the function of coding the angular information carried out by the encoder 64, which makes it possible, where appropriate, to produce the encoder from a material that is more flexible than the reinforcement insert 66.

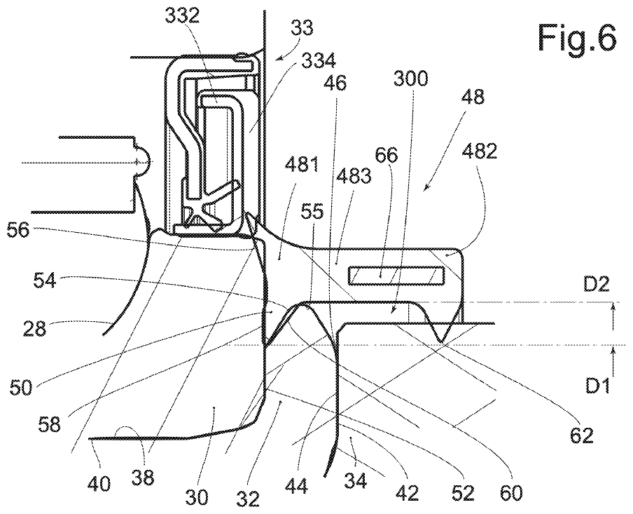

The seal shown in FIG. 6 differs from the preceding ones by the addition of a rigid reinforcement 66, preferably annular, of reinforcement, embedded in the elastomeric body of the seal 48, and located axially at a distance from the fastening portion 50.

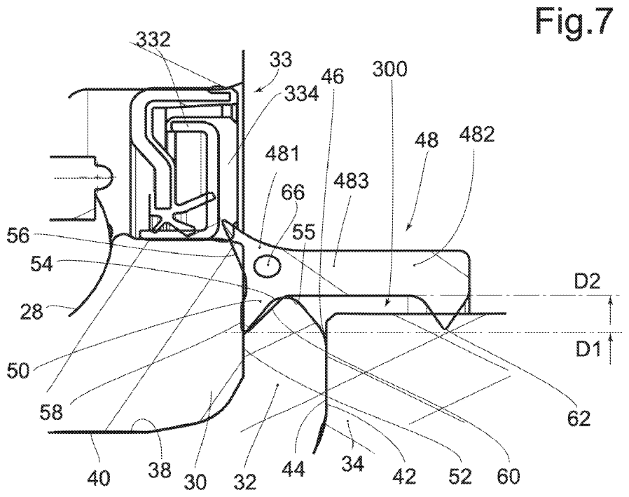

The seal shown in FIG. 7 differs from the preceding one by the positioning of the reinforcement 66, which surrounds the fastening portion 50.

According to the type of propulsion of a motor vehicle, the drive wheel hub assembly 10 is installed on the front wheel set for a traction vehicle, the rear wheel set for a propulsion vehicle, or on both wheel sets for an integral traction motor vehicle.

As indicated in the foregoing description, the various aspects of the invention can be implemented according to the context in variant configurations different from those described above. For example, the splines that allow the transmission of the drive torque to the rotating part of the wheel hub may be radial, facial, frustoconical, or a combination of these embodiments.

Of course, the invention is described in the foregoing by way of example. It is understood that a person skilled in the art is able to produce different variant embodiments of the invention without departing from the scope of the invention.

1. An annular static seal for a drive wheel hub assembly including a wheel hub, a torque converter and an inner race shrunk onto the wheel hub and held axially by a flange forming a rear end of the wheel hub, the static seal defining a reference axis and being adapted, in a mounting position, to cover an annular outer perimeter of an interface between the wheel hub and the torque converter located at the rear end of the wheel hub, the annular static seal comprising:
at least one rear sealing surface adapted, in the mounting position, to be in continuous annular bearing on a rear static seal seat formed on the torque converter, at least one front sealing surface adapted, in the mounting position, to be in continuous annular bearing on a front static seal seat formed on the flange of the wheel hub, on the inner race or on a deflector or an encoder attached to the inner race, and a resiliently deformable annular fastening portion protruding radially toward the reference axis and adapted to be brought into the mounting position by axial movement of the annular static seal toward the inner race and by resilient collapse of the fastening portion when passing the flange of the wheel hub, and to be positioned, in the mounting position, axially between a transverse face of the inner race and a face of the flange of the wheel hub turned toward the inner race to produce a resilient fastening of the annular static seal to the wheel hub.

2. The annular static seal according to claim 1, wherein before mounting, the reference axis is located at a distance D1 from the fastening portion and at a distance D2 from a transition portion of the annular static seal, that transition portion being intended to be positioned, in the mounting position, radially opposite a portion of the flange of the wheel hub furthest from the reference axis, and that one or more of the following dimensional features are achieved:
D2−D1>2 mm
D2−D1>5 mm
D2−D1<8 mm
D2−D1<10 mm.

3. The annular static seal according to claim 1, further comprising an intermediate portion connecting the fastening portion and the rear sealing surface or one of the rear sealing surfaces, and adapted, in the mounting position, to cover the outer perimeter of the interface between the wheel hub and the torque converter.

4. The annular static seal according to claim 3, wherein the intermediate portion delimits with the front sealing surface, or one of the front sealing surfaces or the rear sealing surface, or one of the rear sealing surfaces in the mounting position, a sealed annular volume surrounding the outer perimeter of the interface between the wheel hub and the torque converter, of more than 300 mm 3 and less than 2000 mm³.

5. The annular static seal according to claim 1, wherein:
the rear sealing surface or one of the rear sealing surfaces is adapted, in the mounting position, to bear on a cylindrical rear static seal seat formed on the torque converter; and/or
the rear sealing surface or one of the rear sealing surfaces is adapted, in the mounting position, to axially bear on a flat rear static seal seat formed on the torque converter; and/or
the rear sealing surface or one of the rear sealing surfaces is adapted, in the mounting position, to bear on a frustoconical rear static seal seat formed on the torque converter; and/or
the rear sealing surface or one of the rear sealing surfaces is formed by a sealing lipadapted, in the mounting position, to bear against a rear static seal seat formed on the torque converter, the sealing lip having a converging profile oriented toward the torque converter.

6. The annular static seal according to claim 1, comprising a body made of a plastic material and forming at least in part the fastening portion.

7. The annular static seal according to claim 6, further comprising a reinforcement made of a material that is more rigid than the body, and wherein:
the reinforcement is adapted, in the mounting position, to be shrunk onto the torque converter; and/or
the reinforcement surrounds the rear sealing surface; and/or
the reinforcement surrounds the fastening portion; and/or
the reinforcement constitutes a magnetic encoder or an optical encoder; and/or
the reinforcement carries a magnetic encoder or an optical encoder.

8. The annular static seal claim 1, further including:
a baffle device protruding radially outwards and able to mate with a complementary element rigidly connected to a wheel support and located near the annular static seal in the mounting position; and/or
a magnetic encoder or an optical encoder.

9. The annular static seal claim 1, wherein:
the front sealing surface or one of the front sealing surfaces is formed on the fastening portion; and/or
the front sealing surface or one of the front sealing surfaces is adapted, in the mounting position, to be in continuous annular bearing against a face of the flange facing toward the inner race; and/or
the front sealing surface or one of the front sealing surfaces is adapted, in the mounting position, to be in continuous annular bearing against a face of the flange facing away from the reference axis.

10. The annular static seal claim 1, wherein the front sealing surface or one of the front sealing surfaces is adapted, in the mounting position, to be in continuous annular bearing with the inner race or on a deflector or an encoder attached to the inner race, and wherein:
the front sealing surface or one of the front sealing surfaces is adapted, in the mounting position, to radially bear on a cylindrical front static seal seat formed on the inner race or on a deflector or an encoder attached to the inner race; and/or
the front sealing surface or one of the front sealing surfaces is adapted, in the mounting position, to axially bear on a flat front static seal seat formed on the inner race or on a deflector or an encoder attached to the inner race; and/or
the front sealing surface or one of the front sealing surfaces is adapted, in the mounting position, to bear on an edge formed on the inner race or on a deflector or an encoder attached to the inner race; and/or
the front sealing surface or one of the front sealing surfaces is formed by a front sealing lip adapted, in the mounting position, to bear on a front static seal seat formed on the race or on a deflector or an encoder attached to the inner race.

11. The annular static seal claim 1, wherein the front sealing surface(s) include at least one first front sealing surface adapted, in the mounting position, to bear on a first front static seal seat formed on the inner race or on a deflector or an encoder attached to the inner race, and a second front sealing surface adapted, in the mounting position, to bear on a front static seal seat formed on the flange of the wheel hub.

12. A vehicle drive wheel hub assembly comprising:
a wheel hub;
a torque converter;
an inner race shrunk onto the wheel hub and axially retained by a flange forming a rear end of the wheel hub;
the wheel hub and the torque converter having an interface with an annular outer perimeter at the rear end of the wheel hub; and
an annular static seal according to claim 1, positioned in the mounting position and the reference axis of which coincides with an axis of revolution of the wheel hub.

13. The vehicle drive wheel hub assembly according to claim 12, wherein the torque converter includes a set of splines and radial ribs mating with a set of splines and radial ribs formed on the wheel hub, and located axially at a distance from the rear end of the wheel hub.

14. The vehicle drive wheel hub assembly according to claim 13, wherein the wheel hub includes a planar, toroidal or frustoconical annular rear contact surface in surface contact with a planar, toroidal or frustoconical annular contact surface of the torque converter, the outer perimeter being formed on an outer periphery of the rear contact surface of the wheel hub and of the annular contact surface of the torque converter.

15. The vehicle drive wheel hub assembly according to claim 12, wherein the torque converter includes a set of face splines and ribs mating with a set of face splines formed at the rear end of the wheel hub.

16. The vehicle drive wheel hub assembly according to claim 12, wherein the static seal, and a sealed annular volume surrounding the outer perimeter of the interface between the wheel hub and the torque converter is filled with an at least partially liquid or pasty product.
